(19) United States
(12) Patent Application Publication
(10) Pub. No.: US 2015/0113296 A1
(43) Pub. Date: Apr. 23, 2015

(54) SYSTEM AND METHOD FOR AUTOMATED INVENTORY OF POWER RECEPTACLE, ASSET, AND RACK SPACE LOCATIONS

(71) Applicant: Trippe Manufacturing Company, Chicago, IL (US)

(72) Inventors: David Slotten, Apple Valley, MN (US); Craig Watkins, LaGrange Park, IL (US); John McNally, Chicago, IL (US); John Variakojis, Lockport, IL (US); Mike Delgrosso, Frankfort, IL (US)

(21) Appl. No.: 14/056,759

(22) Filed: Oct. 17, 2013

(51) Int. Cl. G06F 1/26

(52) U.S. Cl. CPC G06F 1/266
USPC 713/310

(57) ABSTRACT

A system for automated identification of assets, power receptacles, and rack space locations includes a data collection unit; a first power distribution unit in communication with the data collection unit, the first power distribution unit having a first power receptacle. The system also includes a first receptacle identification unit associated with the first power receptacle; a first power cable, where the first power cable is connected to the first power receptacle to provide power to an asset; a first receptacle reader connected to the first power cable and interfaced with the first receptacle identification unit; a controller in communication with the data collection unit; and a link module which electronically connects the data collection unit with the first receptacle reader.

### BACKGROUND

The present invention relates to systems and methods for automated identification of power receptacles, assets, and rack space locations.

Software-based Network Management Systems (NMS) are often used to help document the infrastructure of data centers. Upon running a network discovery, the NMS identifies which network-based assets (e.g. servers and switches) are connected to the network. This is particularly important and valuable information when many assets are connected and must be identified, such as in a data center. However, existing systems suffer from a number of deficiencies which make them more labor-intensive to set up and operate and more prone to human error.

### SUMMARY

In one embodiment, a system for automated identification of assets, power receptacles, and rack space locations includes a data collection unit, a first power distribution unit, a first receptacle identification unit, a first power cable, a first receptacle reader, a controller, and a link module. The first power distribution unit is in communication with the data collection unit and has a first power receptacle. The first receptacle identification unit is associated with the first power receptacle. The first power cable is connected to the first power receptacle to provide power to an asset. The first receptacle reader is connected to the first power cable and is interfaced with the first receptacle identification unit. The controller is in communication with the data collection unit. The link module electronically connects the data collection unit with the first receptacle reader.

In another embodiment, a method for automated identification of assets, power receptacles, and rack space locations includes the steps of providing a data collection unit, a controller, and a first power distribution unit, the data collection unit being in communication with the controller and the first power distribution unit; connecting a first power cable from an asset to a first power receptacle of the first power distribution unit to provide power to the asset, the first power receptacle having a first receptacle identification unit associated therewith; coupling a first receptacle reader associated with the first power cable to the first receptacle identification unit; using a link module and an electronically readable asset identifier of an asset, electronically connecting the data collection unit with the first receptacle reader; transmitting a command from the controller to the data collection unit to obtain asset identification information from the asset identifier; transmitting a command from the controller to the receptacle identification unit to emit an identifying signal; the data collection unit obtaining receptacle identification information from the first receptacle reader; and the controller associating the asset identification information and the receptacle identification information with a rack space location.

In yet another embodiment, a system for automated identification of assets, power receptacles, and rack space locations includes a data collection unit, a first power distribution unit, a first receptacle identification unit, a first power cable, a first receptacle reader, and a link module. The first power distribution unit is in communication with the data collection unit and has a first power receptacle. The first receptacle identification unit is associated with the first power receptacle. The first power cable is connected to the first power receptacle to provide power to an asset. The first receptacle reader is connected to the first power cord and is interfaced with the first receptacle identification unit. The link module electronically connects the data collection unit with the first receptacle reader.

In still another embodiment, a system for automated identification of assets, power receptacles, and rack space locations includes a data collection unit, a controller, and a link module. The controller is in communication with the data collection unit. The link module electronically connects the data collection unit with the first receptacle reader.

Other aspects of the invention will become apparent by consideration of the detailed description and accompanying drawings.

### BRIEF DESCRIPTION OF THE DRAWINGS

FIG. 1a shows a diagram of an embodiment of a system for automated identification of power receptacles, assets, and rack space locations.

FIG. 1b shows a diagram of another embodiment of a system for automated identification of power receptacles, assets, and rack space locations.

FIG. 2 shows a diagram of an embodiment of a system for automated identification only of assets and rack space locations.

FIG. 3 shows an embodiment of a system as in FIG. 1a for automated identification of power receptacles, assets, and rack space locations, providing additional details of the components used for receptacle identification and asset identification.

FIG. 4 shows a block diagram of the data collection unit.

FIG. 5 shows a block diagram of a system as in FIG. 2 and particularly the link module.

FIG. 6a shows a side view of a receptacle identification unit including an LED and light pipe assembly inside a PDU.

FIG. 6b shows a side view of a receptacle identification unit including an LED and modified light pipe assembly inside a PDU.

FIGS. 6c and 6d show the coupling of a receptacle reader to a modified light pipe assembly such as that shown in FIG. 6b.

FIG. 6e shows an embodiment of a receptacle identification unit electrically coupled to a receptacle reader using a phono plug and jack.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

While systems are known for identifying assets in data centers, these have a number of drawbacks. Some asset identification systems require all assets to be manually labeled, for example by attaching a tag to each asset, after which information about each item must be manually recorded in a database in association with the tag number. However, manually tagging and logging all of the assets is labor-intensive and costly and is susceptible to human error. Other systems which rely on RFID tags for identification of assets and/or power receptacles have the drawback that RFID tags are more difficult to read when they are present in high density settings and in the presence of background electrical interference, as would be the case at a data center. Finally, a number of systems only track assets and do not associate each asset with its power receptacle(s).

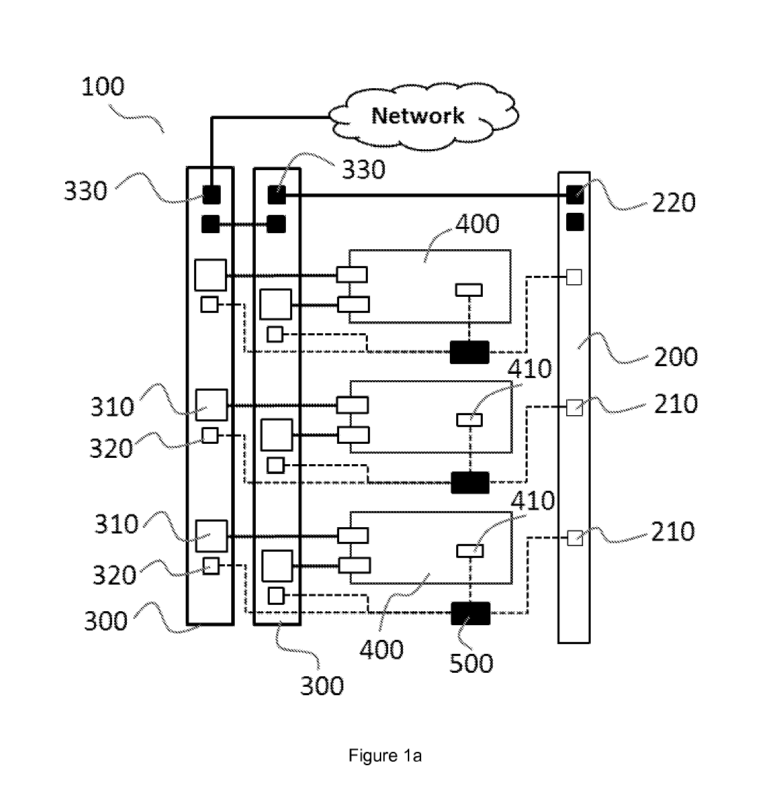

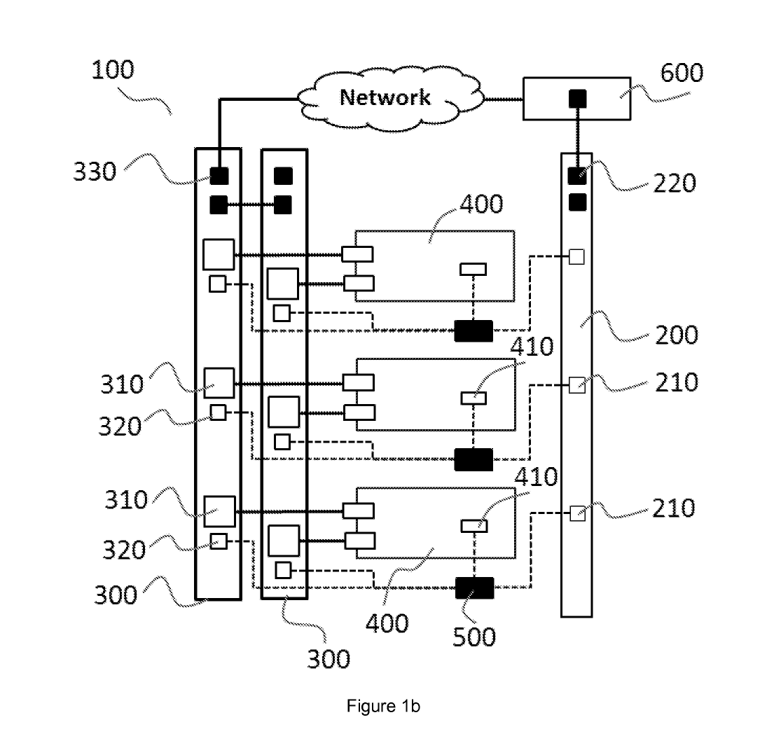

Disclosed herein is a system 100 for automated identification of assets, power receptacles, and rack space locations of each asset which addresses the deficiencies of other systems. In one embodiment, the system 100 includes a data collection unit (DCU) 200, a power distribution unit (PDU) 300, an asset 400, and a link module 500 (FIG. 1a). In another embodiment, the system 100 includes a data collection unit (DCU) 200, a power distribution unit (PDU) 300, an asset 400, a link module 500, and a controller 600 (FIG. 1b). In still another embodiment, the system 100 includes a DCU 200, a controller 600, an asset 400, and a link module 500 (FIG. 2).

The controller 600 (FIGS. 1b, 2) includes a microprocessor, memory, storage, and input/output including networking capabilities. Operation of the controller 600 is controlled by software which includes instructions for execution by a microprocessor for carrying out embodiments of the systems and methods disclosed herein. The software may reside within the controller 600 or, alternatively, part or all of the software may be stored in a location separate from the controller 600. The controller 600 contains an embedded web-based interface so that users may remotely configure and monitor the devices in communication with the controller 600, including the DCUs 200 and PDUs 300.

In some embodiments, the power distribution unit (PDU) 300 may include a microprocessor, memory, storage, and input/output including networking capabilities (FIGS. 1a, 1b). Operation of the PDU 300 in such embodiments is controlled by software which includes instructions for execution by a microprocessor for carrying out embodiments of the systems and methods disclosed herein. The software may reside within the PDU 300 or, alternatively, part or all of the software may be stored in a location separate from the PDU 300. In some embodiments, the PDU 300 contains an embedded web-based interface so that users may remotely configure and monitor the devices reporting into the PDU 300. Thus, in certain embodiments the PDU 300 may perform control functions such that a separate, standalone controller 600 is not required as the controller 600 is effectively contained within the PDU 300 (FIG. 1a).

In other embodiments, for example those in which the PDUs 300 do not include a microprocessor and related components or in which the PDUs 300 are not compatible with the rest of the system 100, a standalone controller 600 would be used to perform automated identification of assets 400 and rack space locations of each asset 400 (FIG. 2). However, in this latter embodiment it would be necessary to manually associate each asset 400 with a particular PDU and receptacle.

In still other embodiments, a standalone controller 600 may be used even where the PDUs 300 include components (e.g. a microprocessor, memory, storage, and input/output including networking capabilities) which permit the PDUs 300 to perform control functions (FIG. 1b). In such embodiments, the software of the PDU 300 and controller 600 would be configured to coordinate actions and in one particular embodiment the controller 600, when present, would override control by the PDUs 300.

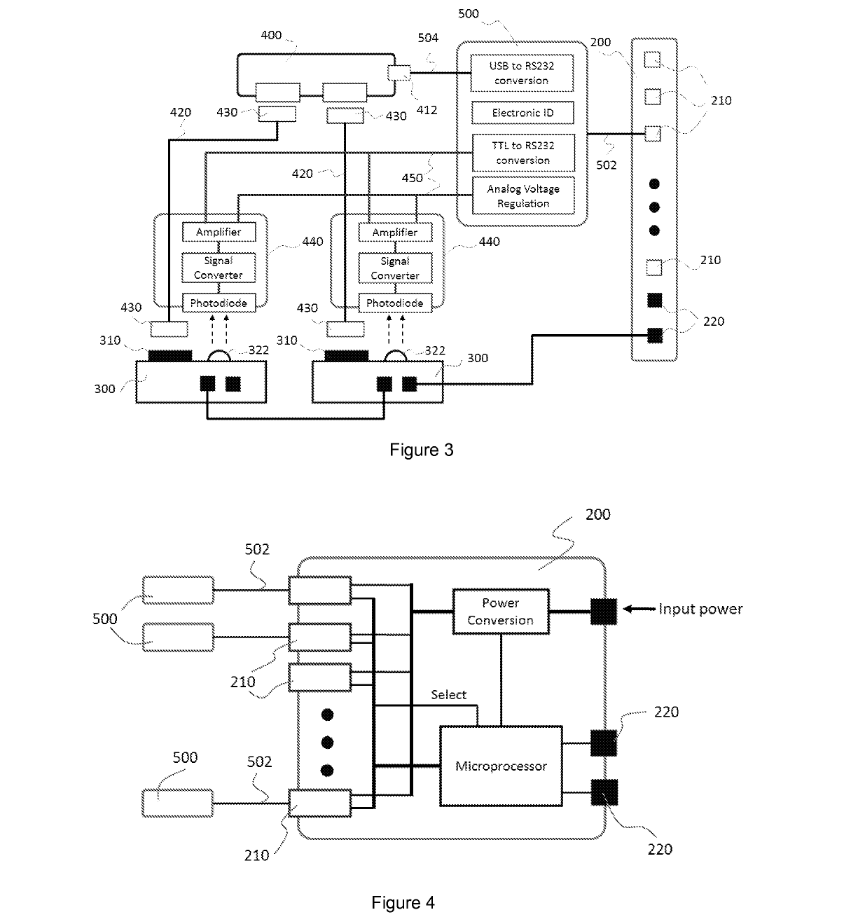

The DCU 200 generally includes multiple rack unit (RU) ports 210 to which one branch of the link module 500 is connected (FIG. 4). The DCU 200 also includes two management ports 220, one of which is connected to a PDU 300 (FIGS. 1a, 1b) or Controller 600 (FIG. 2). The DCU 200 also includes an input power port, a power conversion unit, and a microprocessor (FIG. 4). The second management port 220 is redundant and can optionally be used. For example, in a taller rack having a large number of assets 400, more than one PDU 300 might be used to provide enough power receptacles for all of the assets 400. In a case such as this, a second PDU 300 could be connected to one of the management ports 220 of the DCU 200.

The PDU 300 generally includes multiple power receptacles 310 where each receptacle 310 has a receptacle identification unit 320 associated therewith (FIGS. 1a, 1b). The PDU 300 is directly connected to the management port 220 of the DCU 200, either through a direct connection, e.g. through its PDU management port 330, or through a network such as the Internet.

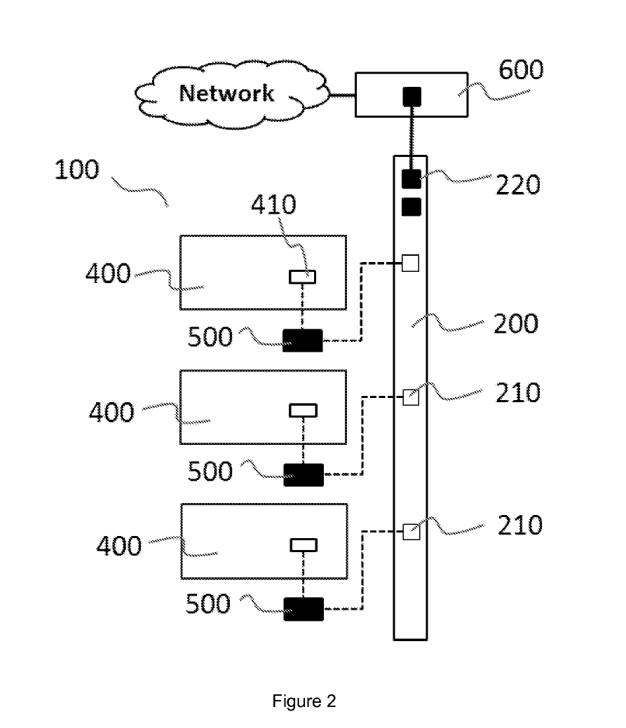

The asset 400 includes an asset identifier 410 and at least one power input (FIGS. 1a, 1b, 2). A power cable 420 is connected at one end to the asset 400 and at the other end to the PDU 300 using a plug 430 at each end. In various embodiments, the power cable 420 has a receptacle reader 440 associated with the plug 430 at the PDU 300 end. In various embodiments, the power cable 420 has a reader link 450 associated with the plug 430 at the asset 500 end (FIG. 3). The reader link 450 is electrically connected to the link module 500, which is described below.

The asset identifier 410 is generally a management/configuration port 412 of the asset 400, although in some cases (e.g. if the asset lacks a management port or if the asset's management port is not compatible with other components of the system) the link module 500, which contains an embedded unique electronic identification, may be attached to the asset 400. In still other embodiments, an electronically-readable asset tag 414 may be used (see below). With either the use of the management port 412/asset tag 414 (via the link module 500) or the link module 500 (by itself), the asset 400 is identified by the PDU 300 or controller 600 polling the asset identifier 410 (via the DCU 200), with the link module 500 or port 412/asset tag 414 (when present) electronically returning suitable identification codes. Since the identity of the link module 500 is returned in both cases, thereby attributing a second identity to an asset with a management port 412/asset tag 414, the system 100 software may disregard the link module 500 identity, retaining the port 412/asset tag 414 identity as the sole asset identifier 410 of that asset 400. In some embodiments, it may be necessary to modify the control software of the asset 400 so that it returns a suitable identification code in response to the polling from the PDU 300 or controller 600.

In some embodiments, the asset 400 may include more than one power input, and therefore more than one power cable 420, in order to provide a backup power source in the event power to the first power cable 420 is lost. Although one or two power cables 420 are shown and described in the embodiments disclosed herein, in various other embodiments other numbers of power cables 420 may be used. In order to provide an independent source of power, each power cable 420 is generally coupled to a separate PDU 300 (FIGS. 1, 3).

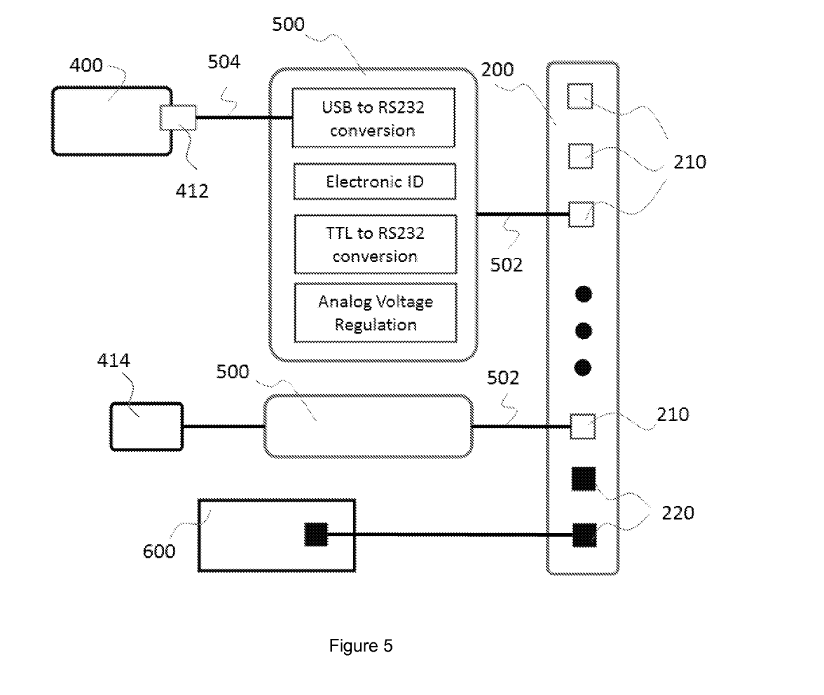

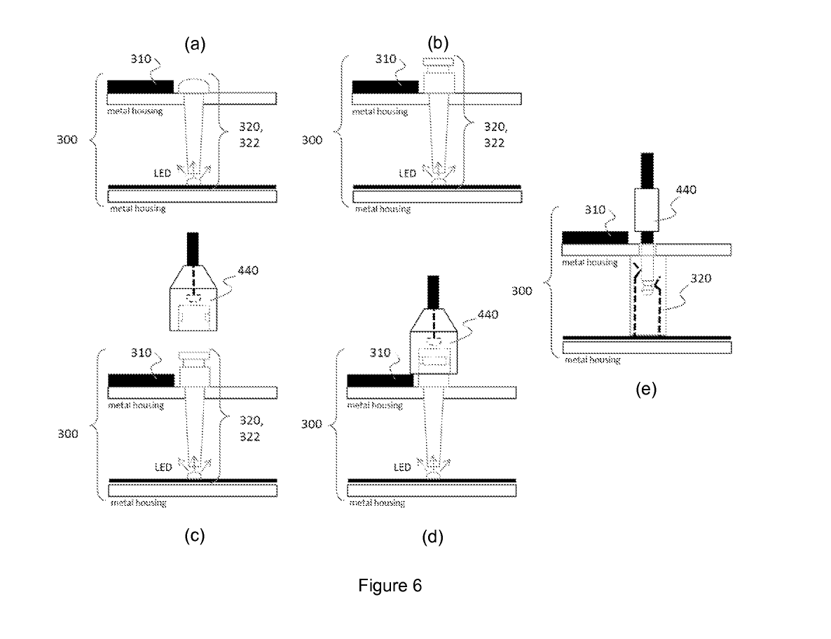

FIG. 3 shows an embodiment of a system 100 as in FIG. 1a for automated identification of power receptacles, assets, and rack space locations. FIG. 5 shows a block diagram of a system 100 as in FIG. 2 with a focus on the link module 500. In various embodiments, the receptacle identification unit 320 includes a light source 322 such as an LED adjacent to the receptacle 310, and the receptacle reader 440 (which may include a photodiode) is configured to receive light from the light source 322 and convert the light to an electronic signal (FIGS. 5, 6d). In certain embodiments, the receptacle reader 440 may include a photodiode, a signal converter, and an amplifier, where the amplifier is then electrically connected to the link module 500 (e.g. to an analog voltage regulation component) (FIG. 5). The light source 322 emits a distinct signal, e.g. blinks on and off in a pattern that distinguishes each light source from other light sources and thereby identifies the receptacle identification unit 320. The blinking pattern is detected by the receptacle reader 440, which then generates an electrical signal that is transmitted to the DCU 200 via the link module 500. The receptacle reader 440 may simply convert the blinking pattern to an electrical signal or it may translate the blinking pattern (e.g. using a lookup table) to a particular identification code that is subsequently transmitted to the DCU 200.

In general, the light source 322 includes a light emitter (LED) with a light pipe adjacent to the emitter, where the light pipe directs light from the emitter within PDU 300 to a location outside the housing of the PDU 300 (FIGS. 6a-6d). In some embodiments, the light pipe may be modified to more effectively transmit light to the receptacle reader 440 and to facilitate coupling of the receptacle reader (FIGS. 6b-6d). In some embodiments, a PDU 300 may be retro-fitted with such a light pipe and a controller of the PDU 300 may be adapted (e.g. by installing updated firmware) so that the light source 322 associated with each receptacle 310 emits a distinct signal such as a blinking pattern which uniquely identifies the receptacle 310 and the PDU 300 to which it belongs.

In other embodiments, the receptacle identification unit 320 and the receptacle reader 440 make a direct (wired) electrical and mechanical connection with one another (FIG. 6e). For example, the receptacle reader 440 may be a plug and the receptacle identification unit 320 may be a mating receptacle (sometimes referred to as a ‘jack’), e.g. a ⅛ inch phono plug and matching jack, although various sizes and styles of plug-receptacle combinations may be used provided the connection that is made is suitable for transmitting the signal. In certain embodiments, the plug corresponding to the receptacle identification unit 320 fits into the socket corresponding to the receptacle reader 440 in a manner that facilitates rapid and secure installation and quick removal. The PDU 300 is configured to transmit an electrical signal which provides a distinct identification signal through the connection formed by the receptacle identification unit 320 and the receptacle reader 440. The receptacle reader 440 then transmits a signal to the DCU 200 to identify the receptacle identification unit 320, indicating the PDU 300 and receptacle 310 detected by the receptacle reader 440.

In general, the receptacle reader 440 is attached to a power cable 420 (e.g. to the plug 430 or the cord at the PDU 300 end) to assure that the receptacle reader 440 is associated with the correct power cable 420 and asset 400. The receptacle reader 440 needs to be associated with the power cable 420 so that the correct receptacle 310 is associated with the correct asset 400, which permits monitoring and control of the asset 400, for example to monitor power consumption and to permit remote resetting of the asset 400. The receptacle reader 440 may be loosely tethered to the power cable 420 or may be mounted onto the plug 430 so that the reader 440 aligns with the receptacle identification unit 320 when the plug 430 is connected with the receptacle 310.

Likewise, the reader link 450 is attached to a power cable 420 (e.g. to the plug 430 or the cord at the asset 400 end) to assure that the reader link 450 is associated with the correct power cable 420 and asset 400. The reader link 450 may be loosely tethered to the power cable 420 or may be mounted onto the plug 430 so that the correct asset 400 is associated with the correct link module 500.

In various embodiments, the link module 500 includes an electronic ID module, a USB to RS232 conversion module, a TTL to RS232 conversion module, and an analog voltage regulation module, although other configurations are also possible. The link module 500 (FIGS. 3, 5) includes three ‘legs’, namely a DCU connection 502, an asset identifier connection 504, and a reader link 450 connection. In various embodiments, each of the legs may be hard-wired to the link module 500 or removably plugged into receptacles within the link module 500. The link module 500 performs the function of converting the signals and protocols from the receptacle readers 440 and assets 400 into the communication format used by the system 100. The link module optionally serves as an asset identifier 410, described above.

In one embodiment, the data collection unit cable 502 is removably plugged into suitable receptacles on the link module 500 and on the DCU 200, using a CATSe or comparable cable with RJ-45 connectors at each end (FIG. 3), which in some embodiments may include a cord retraction device.

The asset identifier cable 504 in one embodiment is removably plugged into a suitable receptacle on the link module 500 and the asset's management port 412, e.g. a USB connector (FIG. 3). In some embodiments in which an asset tag 414 is used (FIG. 5) instead of a connection to the management port 412, the asset identifier cable 504 may be attached to the asset tag 414 using a suitable connector, e.g. a ⅛ inch phono plug into a mating jack on the asset tag 414 or other suitable connection. In such embodiments, the asset tag 414 is attached to the asset 400, for example using double-sided tape or adhesive.

The reader link 450 and a length of cable associated therewith may be tethered to the power cable 420 (e.g. using tape or cable ties) or integrated into the power cable 420 (FIG. 3). In the embodiment shown in FIG. 3, the reader link 450 is a phono plug integrated into the power cable 420 such that the plug portion is located at the end of the power cable 420 and mates with the reader link 450 receptacle of the link module 500. Each link module 500 contains two receptacles in order to accept the reader links 450 of each of two power cords 420 that are connected to the same asset 400 (primary and back-up power). In various embodiments the link module 500 may contain additional receptacles to accept more than two reader links 450 if the asset 400 has more than two power cords 420.

The receptacle reader 440 and a length of cable associated therewith may be tethered to the power cable 420 (e.g. using tape or cable ties) or integrated into the power cable 420. In the embodiment shown in FIG. 3, the receptacle reader 440 is integrated into the power cable 420 such that the reader portion is located at the end of the power cable 420 that couples to the PDU 300.

When adding or rearranging assets 400 (e.g. within a data center), a user installs the asset 400 in a rack and connects the link module 500 to the DCU 200, the asset identifier 410 of the asset 400, the reader links 450, and the receptacle identification unit(s) 320 (FIGS. 1a, 1b, 3). Each rack has its own DCU 200 and PDU(s) 300 so that determining which rack a particular asset 400 is associated with can be based on the DCU 200 and/or PDU(s) 300 to which the asset 400 is connected. Each PDU 300 includes a management port which is connected (e.g. using a CATSe or similar cable) to a management port 220 on the DCU 200.

In one configuration, the DCU 200 is a vertical strip that is mounted to a portion of the rack, where each DCU 200 includes a rack unit port 210 for each rack space location in the rack. When installing an asset 400 at a given level of the rack, the user attaches cabling to the DCU 200 at a level that corresponds to the level on the rack of the particular asset 400. For example, if the asset 400 is located in RU space 2 of the rack, then the user would attach the DCU cable 502 of the link module 500 into the #2 rack unit port 210 of the DCU 200. For larger assets 400 that are more than one rack unit in height and which have more than one rack unit port 210 associated therewith, the system 100 can be configured such that all of the rack unit ports 210 associated with the asset 400 are tied (in software) to a single, representative rack unit port—instance, the highest rack unit port 210 adjacent to the asset 400—to which the link module 500 of the asset 400 is connected (via DCU cable 502). Based on the physical size or configuration of the asset 400 and its associated cabling, the system 100 can then determine not only the particular rack and PDU 300 that an asset 400 is associated with, but also the exact level of the asset 400 within the rack.

While the asset identifier 410 is usually determined via a management port 412, if a given asset 400 does not have a management port or the management port is incompatible with the system 100, the link module 500 may be attached to the asset 400 to act as its asset identifier 410, as described above. The asset link module 500 includes an electronically-readable code which is entered into a database that is accessible to the PDU 300 or controller 600 so that the electronically-readable code is logically associated with the given asset 400.

Referencing the system 100 configuration depicted in FIG. 1a, when all of the hardware components (e.g. assets 400, link modules 500 and associated cabling) have been connected, the PDU 300 transmits a series of commands to the system 100 components. The PDU 300 instructs each of its own receptacle identification units 320 to emit an identifying signal that can be received by the receptacle readers 440, either by having the light source 322 emit a distinct signal (e.g. blinking) or by having the receptacle identification units 320 emit a suitable electronic signal. At the same time, the PDU 300 instructs the DCU 200 to gather the receptacle identification information, via the link module 500, at each RU port 220 of the DCU 200. The PDU 300 also transmits commands to the DCU 200 to gather the asset identifier 410 (e.g. management port 412 or link module 500) information, via the link module 500, at each RU port 220 of the DCU 200. The PDU 300 also measures the power output at each of its receptacles 310. When aggregating the aforementioned information, the PDU 300 associates the power consumption of each asset 400 with the asset's identity and the RU space it occupies, for all assets 400 in the rack.

When both PDUs 300 and a controller 600 are present, as in the system 100 configuration depicted in FIG. 1b, a similar procedure as that outlined above is executed, with the PDUs 300 and controller 600 coordinating commands to the system 100 components including the DCU 200 and PDU 300. In some embodiments, when a controller 600 is present the PDUs 300 are programmed not to issue commands to the DCUs 200 and instead the controller 600 issues commands to the DCUs 200 and the PDUs 300. In other embodiments the controller 600 issues commands to the PDUs 300 which in turn issue commands to the DCUs 200 as well as to the receptacle identification units 320 as described above.

Referencing the system 100 configuration depicted in FIG. 2, when all of the hardware components (e.g. assets 400, link modules 500 and associated cabling) have been connected, the controller 600 transmits commands to the DCU 200 to gather the asset identifier 410 (e.g. management port 412 or link module 500) information, via the link module 500, at each RU port 220 of the DCU 200. Thereby, when aggregating the aforementioned information, the controller 600 associates the identity of each asset 400 with the RU space it occupies, for all assets 400 in the rack.

In various embodiments, the PDU 300 collects information including one or more of: information about the asset 400 (e.g. name, model, firmware information), the rack level at which the asset 400 is located, and the power consumption of the asset 400. The information may be stored on the PDU 300 and/or transmitted to one or more other computers for subsequent storage and analysis. The information can be used for monitoring power consumption of individual assets or of PDUs, troubleshooting (e.g. determining if an asset is consuming any power to determine if it is operating), and restarting one or more assets (e.g. by cycling the power to a particular receptacle via the PDU). Other uses for this information include monitoring data center performance and metrics, assessing asset utilization, and capacity planning.

In various embodiments, the controller 600 collects information including one or more of: information about the asset 400 (e.g. name, model, firmware information) and the rack level at which the asset 400 is located. The information may be stored on the controller 600 and/or transmitted to one or more other computers for subsequent storage and analysis. The information can be used for quickly locating individual assets during maintenance and troubleshooting procedures.

Various features and advantages of the invention are set forth in the following claims.

1. A system for automated identification of assets, power receptacles, and rack space locations, comprising:
a data collection unit;
a first power distribution unit in communication with the data collection unit, the first power distribution unit having a first power receptacle;
a first receptacle identification unit associated with the first power receptacle;
a first power cable, the first power cable connected to the first power receptacle to provide power to an asset;
a first receptacle reader connected to the first power cable and interfaced with the first receptacle identification unit;
a controller in communication with the data collection unit; and
a link module which electronically connects the data collection unit with the first receptacle reader.

2. The system of claim 1, wherein the controller is configured to:
transmit a command to the data collection unit to obtain asset identification information from the asset identifier,
transmit a command to the receptacle identification unit to emit an identifying signal, and
collect receptacle identification information from the first receptacle reader.

3. The system of claim 2, wherein the controller is further configured to associate the asset identification information and the receptacle identification information with a rack space location.

4. The system of claim 1, wherein the first receptacle identification unit comprises a light source configured to emit an identifying light pattern and wherein the first receptacle reader is configured to read the identifying light pattern and transmit a signal to the data collection unit based on the identifying light pattern.

5. The system of claim 4, wherein the first receptacle reader transmits a signal to the data collection unit identifying at least one of the first power receptacle and the first power distribution unit.

6. The system of claim 1, wherein the first receptacle identification unit comprises a jack and the first receptacle reader comprises a plug configured to connect with the jack and receive a signal identifying the first power receptacle.

7. The system of claim 1, further comprising a second power distribution unit having a second receptacle with a second receptacle identification unit associated therewith, wherein the asset comprises a second power cable which plugs into the second receptacle to provide power to the asset, the second power cable including a second receptacle reader which interfaces with the second receptacle identification unit, wherein the link module is in electronic communication with the second receptacle reader.

8. The system of claim 1, wherein the asset is a server or a switch.

9. The system of claim 1, wherein the link module comprises a junction box having three cables attached thereto.

10. The system of claim 1, wherein the controller is housed within the power distribution unit.

11. A method for automated identification of assets, power receptacles, and rack space locations, the method comprising the steps of:
providing a data collection unit, a controller, and a first power distribution unit, the data collection unit being in communication with the controller and the first power distribution unit;
connecting a first power cable from an asset to a first power receptacle of the first power distribution unit to provide power to the asset, the first power receptacle having a first receptacle identification unit associated therewith;
coupling a first receptacle reader associated with the first power cable to the first receptacle identification unit;
using a link module, electronically connecting the data collection unit with the first receptacle reader using an electronically readable asset identifier of an asset;
transmitting a command from the controller to the data collection unit to obtain asset identification information from the asset identifier;
transmitting a command from the controller to the receptacle identification unit to emit an identifying signal;
the data collection unit obtaining receptacle identification information from the first receptacle reader; and
the controller associating the asset identification information and the receptacle identification information with a rack space location.

12. The method of claim 11, wherein the electronically-readable asset identifier comprises a management port, an asset tag, or a link module.

13. The method of claim 11, wherein the first receptacle identification unit comprises a light source, the method further comprising
the light source emitting an identifying light pattern;
the first receptacle reader reading the identifying light pattern; and
the first receptacle reader transmitting a signal to the data collection unit based on the identifying light pattern.

14. The method of claim 13, further comprising the first receptacle reader transmitting a signal to the data collection unit identifying the first power receptacle and the first power distribution unit.

15. The method of claim 11, wherein the first receptacle identification unit comprises a jack and the first receptacle reader comprises a plug configured to connect with the jack, the method further comprising the first receptacle reader receiving a signal identifying the first power receptacle.

16. The method of claim 11, further comprising
providing a second power distribution unit having a second receptacle with a second receptacle identification unit associated therewith;
connecting a second power cable of the asset into the second receptacle to provide power to the asset;
coupling a second receptacle reader associated with the second power cable to the second receptacle identification unit; and
electronically connecting the data collection unit with the second receptacle reader using the link module.

17. The method of claim 11, wherein the asset is a server or a switch.

18. The method of claim 11, wherein the link module comprises a junction box having three cables attached thereto.

19. The method of claim 11, wherein the controller is housed within the power distribution unit.

20. A system for automated identification of assets, power receptacles, and rack space locations, comprising:
a data collection unit;
a first power distribution unit in communication with the data collection unit, the first power distribution unit having a first power receptacle; a first receptacle identification unit associated with the first power receptacle;
a first power cable, the first power cable connected to the first power receptacle to provide power to an asset;
a first receptacle reader connected to the first power cord and interfaced with the first receptacle identification unit; and
a link module which electronically connects the data collection unit with the first receptacle reader.

21. The system of claim 20, wherein the first power distribution unit is configured to:
transmit a command to the data collection unit to obtain asset identification information from the asset identifier,
transmit a command to the receptacle identification unit to emit an identifying signal, and
collect receptacle identification information from the first receptacle reader.

22. The system of claim 21, wherein the first power distribution unit is further configured to associate the asset identification information and the receptacle identification information with a rack space location.

23. The system of claim 22, wherein the first power distribution unit comprises a controller.

24. A system for automated identification of assets, power receptacles, and rack space locations, comprising:
a data collection unit;
a controller in communication with the data collection unit; and
a link module which electronically connects the data collection unit with a first receptacle reader.

25. The system of claim 24, wherein the controller is configured to transmit a command to the data collection unit to obtain asset identification information from the asset identifier.

26. The system of claim 25, wherein the controller is further configured to associate the asset identification information with a rack space location.
